(19) United States
(12) Patent Application Publication
(10) Pub. No.: US 2026/0152672 A1
(43) Pub. Date: Jun. 4, 2026

(54) STRUCTURE, ELECTRONIC COMPONENT DEVICE, AND METHOD FOR MANUFACTURING STRUCTURE

(71) Applicant: RESONAC CORPORATION, Tokyo (JP)

(72) Inventors: Masashi SHIRAGAMI, Minato-ku, Tokyo (JP); Shuhei NEGORO, Minato-ku, Tokyo (JP); Kazuya KAMIMURA, Minato-ku, Tokyo (JP); Xin JIANG, Minato-ku, Tokyo (JP); Kouzi USUI, Minato-ku, Tokyo (JP)

(73) Assignee: RESONAC CORPORATION, Tokyo (JP)

(21) Appl. No.: 18/861,571

(22) PCT Filed: Nov. 21, 2023
(86) PCT No.: PCT/JP2023/041836

§ 371 Date: Oct. 29, 2024

(30) Foreign Application Priority Data
Nov. 25, 2022 (JP) 2022-188726

(51) Int. Cl. C09J 7/35; B32B 15/092; C09J 5/06

(52) U.S. Cl. CPC C09J 7/35; B32B 15/092; C09J 5/06; B32B 2250/02; B32B 2457/00; C09J 2203/326; C09J 2301/304; C09J 2400/166; C09J 2463/00

(57) ABSTRACT

A structure includes a resin member, and a metal film that is arranged on the surface of the resin member. The resin member includes a cured product of an epoxy resin and a curing agent. The curing agent includes a nitrogen-containing phenol novolak resin.

### TECHNICAL FIELD

The disclosure relates to a structure, an electronic component device, and a method for manufacturing a structure.

### RELATED ART

Resin such as epoxy resin is widely used as a material for a sealing material that protects a periphery of an electronic component in an electronic component device such as a semiconductor package (for example, see Patent Document 1).

Patent Document 1: Japanese Patent Laid-open No. 2021-027315

### SUMMARY OF THE INVENTION

### Problems to be Solved by the Invention

As electronic equipment has been reduced in size and improved in functionality in recent years, a mounting density of electronic components within an electronic component device has been increasing. As a result, it has become a problem that noise generated from the electronic component device causes electromagnetic interference with surrounding electronic equipment.

One method for suppressing electromagnetic interference is to further cover a surface of a resin member arranged around the electronic component device with a metal film.

However, upon evaluating, under specific conditions, adhesion between the metal film and the resin member with the surface of the resin member arranged around the electronic component covered with the metal film, it has been found that evaluation results of the adhesion differ depending on the type of resin member.

In light of the above circumstances, one embodiment of the disclosure aims to provide a structure that excels in adhesion between a resin member and a metal film arranged on a surface of the resin member, and an electronic component device including this structure. Another embodiment of the disclosure aims to provide a method for manufacturing a structure that excels in adhesion between a resin member and a metal film arranged on a surface of the resin member.

### Means for Solving the Problems

Specific means for solving the aforementioned problems include the following aspects.

<1> A structure includes a resin member, and a metal film arranged on a surface of the resin member. The resin member includes a cured product of an epoxy resin and a curing agent. The curing agent includes a nitrogen-containing phenol novolak resin.

<2> In the structure described in <1>, the nitrogen-containing phenol novolak resin includes a structural unit derived from a triazine compound.

<3> In the structure described in <1> or <2>, the nitrogen-containing phenol novolak resin includes a structural unit derived from melamine.

<4> In the structure described in any one of <1> to <3>, the resin member includes a cured product of a thermosetting resin.

<5> In the structure described in <4>, the thermosetting resin includes an epoxy resin.

<6> An electronic component device includes the structure described in any one of <1> to <5>.

<7> A method for manufacturing a structure includes: preparing a resin member; and arranging a metal film on a surface of the resin member. The resin member includes a cured product of an epoxy resin and a curing agent. The curing agent includes a nitrogen-containing phenol novolak resin.

<8> The method for manufacturing a structure described in <7> further includes: selecting the resin member based on information obtained from an evaluation method including (A), (B), and (C) described below.
(A) A test specimen is prepared including a resin member and a metal film arranged on a surface of the resin member.
(B) As a pretreatment of the test specimen, the following are performed in this order: a treatment in which the test specimen is held in an environment of 60° C. to 100° C. and relative humidity of 60% to 100% for 15 hours or more; and a treatment in which the test specimen is heated under conditions where a maximum attained temperature is 200° C. or higher.
(C) A peeling test of the metal film is conducted using the test specimen after pretreatment.

### Effects of the Invention

According to one embodiment of the disclosure, provided are a structure that excels in adhesion between a resin member and a metal film arranged on a surface of the resin member, and an electronic component device including this structure. According to another embodiment of the disclosure, provided is a method for manufacturing a structure that excels in adhesion between a resin member and a metal film arranged on a surface of the resin member.

### DESCRIPTION OF THE EMBODIMENTS

In the disclosure, the term “process” includes, in addition to processes independent of other processes, processes as long as the purpose of the processes is achieved even if such processes cannot be clearly distinguished from other processes.

In the disclosure, a numerical range expressed with “to” denotes a range including the numerical values stated before and after “to” as a minimum value and a maximum value, respectively.

In the numerical ranges stated stepwise in the disclosure, an upper limit value or a lower limit value of a numerical range may be replaced with an upper limit value or a lower limit value of other numerical ranges that are stated stepwise. In a numerical range stated in the disclosure, an upper limit value or a lower limit value of the numerical range may be replaced with a value indicated in examples.

In the disclosure, each component may include multiple types of corresponding substances. In the case where multiple types of substances corresponding to each component are present in a composition, the content ratio or content of each component means a total content ratio or content of the multiple types of substances present in the composition, unless otherwise specified.

In the disclosure, particles corresponding to each component may include multiple types. In the case where multiple types of particles corresponding to each component are present in a composition, a particle diameter of each component means a value for a mixture of the multiple types of particles present in the composition, unless otherwise specified.

### <Structure>

A structure of the disclosure is a structure including a resin member and a metal film arranged on a surface of the resin member, the resin member including a cured product of an epoxy resin and a curing agent, the curing agent including a nitrogen-containing phenol novolak resin.

The structure including the above configuration excels in adhesion between the resin member and the metal film arranged on the surface of the resin member. The reason for this is considered as follows. The fact that the resin member includes the cured product of the epoxy resin and the curing agent and that the nitrogen-containing phenol novolak resin is included as the curing agent acts to increase the adhesion of the surface of the resin member with respect to the metal film. As a result, a decrease in the adhesion between the resin member and the metal film is suppressed.

### (Metal Film)

A material of the metal film arranged on the surface of the resin member is not particularly limited. Examples thereof include copper, silver, iron, nickel, aluminum, titanium, vanadium, chromium, and alloys containing these metals.

A thickness of the metal film is not particularly limited, and can be selected from, for example, a range of 10 nm to 1000 μm.

### (Epoxy Resin)

The epoxy resin used in the cured product of the epoxy resin and the curing agent is not particularly limited.

Specific examples of the epoxy resin include: novolak-type epoxy resin (such as phenol novolak-type epoxy resin and ortho-cresol novolak-type epoxy resin), formed by epoxidizing novolak resin obtained by condensation or co-condensation under an acidic catalyst of at least one phenolic compound selected from the group consisting of phenol compounds such as phenol, cresol, xylenol, resorcinol, catechol, bisphenol A, and bisphenol F, and naphthol compounds such as β-naphthol, β-naphthol, and dihydroxynaphthalene, with an aliphatic aldehyde compound such as formaldehyde, acetaldehyde, and propionaldehyde; triphenylmethane-type epoxy resin, formed by epoxidizing triphenylmethane-type phenol resin obtained by condensation or co-condensation under an acidic catalyst of the aforementioned phenolic compound with an aromatic aldehyde compound such as benzaldehyde and salicylaldehyde; copolymer-type epoxy resin, formed by epoxidizing novolak resin obtained by co-condensation under an acidic catalyst of the aforementioned phenol compound and naphthol compound with an aldehyde compound; diphenylmethane-type epoxy resin, being a diglycidyl ether of bisphenol A, bisphenol F or the like; biphenyl-type epoxy resin, being a diglycidyl ether of an alkyl-substituted or unsubstituted biphenol; stilbene-type epoxy resin, being a diglycidyl ether of a stilbene-based phenol compound; sulfur atom-containing epoxy resin, being a diglycidyl ether of bisphenol S or the like; epoxy resin, being a glycidyl ether of alcohols such as butanediol, polyethylene glycol, and polypropylene glycol; glycidyl ester-type epoxy resin, being a glycidyl ester of a polyvalent carboxylic acid compound such as phthalic acid, isophthalic acid, and tetrahydrophthalic acid; glycidylamine-type epoxy resin, in which an active hydrogen bonded to a nitrogen atom of aniline, diaminodiphenylmethane, isocyanuric acid or the like is substituted with a glycidyl group; dicyclopentadiene-type epoxy resin, formed by epoxidizing co-condensation resin of dicyclopentadiene and a phenol compound; alicyclic epoxy resin, such as vinylcyclohexene diepoxide, 3,4-epoxycyclohexylmethyl-3,4-epoxycyclohexanecarboxylate, and 2-(3,4-epoxy)cyclohexyl-5,5-spiro(3,4-epoxy)cyclohexane-m-dioxane, in which an olefin bond in a molecule is epoxidized; paraxylylene-modified epoxy resin, being a glycidyl ether of paraxylylene-modified phenol resin; metaxylylene-modified epoxy resin, being a glycidyl ether of metaxylylene-modified phenol resin; terpene-modified epoxy resin, being a glycidyl ether of terpene-modified phenol resin; dicyclopentadiene-modified epoxy resin, being a glycidyl ether of dicyclopentadiene-modified phenol resin; cyclopentadiene-modified epoxy resin, being a glycidyl ether of cyclopentadiene-modified phenol resin; polycyclic aromatic ring-modified epoxy resin, being a glycidyl ether of polycyclic aromatic ring-modified phenol resin; naphthalene-type epoxy resin, being a glycidyl ether of naphthalene ring-containing phenol resin; halogenated phenol novolak-type epoxy resin; hydroquinone-type epoxy resin; trimethylolpropane-type epoxy resin; linear aliphatic epoxy resin, obtained by oxidizing an olefin bond with a peracid such as peracetic acid; and aralkyl-type epoxy resin, formed by epoxidizing aralkyl-type phenol resin such as phenol aralkyl-type phenol resin, biphenyl aralkyl-type phenol resin, and naphthol aralkyl-type phenol resin. Furthermore, an epoxidized product of acrylic resin may also be mentioned as an example of the epoxy resin. One of the epoxy resins may be used alone, or two or more thereof may be used in combination.

From the viewpoint of heat resistance of the resin member, triphenylmethane-type epoxy resin, biphenyl aralkyl-type epoxy resin, naphthalene aralkyl-type epoxy resin, and novolak-type epoxy resin are preferable as the epoxy resin.

An epoxy equivalent (molecular weight/number of epoxy groups) of the epoxy resin is not particularly limited. From the viewpoint of balancing various characteristics such as moldability, reflow resistance, and electrical reliability, the epoxy equivalent is preferably 100 g/eq to 1000 g/eq, and more preferably 150 g/eq to 500 g/eq.

The epoxy equivalent of the epoxy resin is a value measured by a method in accordance with JIS K 7236:2009.

In the case where the epoxy resin is solid, a softening point or melting point thereof is not particularly limited. From the viewpoint of moldability and reflow resistance, the softening point or melting point is preferably 40° C. to 180° C.; from the viewpoint of handleability, the softening point or melting point is more preferably 50° C. to 130° C.

The melting point or softening point of the epoxy resin is a value measured by differential scanning calorimetry (DSC) or by a method (ring and ball method) in accordance with JIS K 7234:1986.

In the case where the resin member includes epoxy resin, a content ratio of the epoxy resin is preferably 0.5 mass % to 50 mass %, and more preferably 2 mass % to 30 mass %, from the viewpoint of strength, flowability, heat resistance, moldability, or the like.

### (Nitrogen-Containing Phenol Novolak Resin)

Examples of the nitrogen-containing phenol novolak resin used in the cured product of the epoxy resin and the curing agent include a phenol novolak resin including a structural unit derived from a triazine compound.

Examples of the triazine compound include 1,3,5-triazine, 1,2,4-triazine, 1,2,3-triazine, and a derivative thereof.

Examples of the derivative of the triazine compound include a triazine compound having a primary amino group (—NH₂) bonded to a triazine ring.

Among the triazine compounds, 1,3,5-triazine and a derivative thereof are preferable, melamine and guanamine are more preferable, and melamine is even more preferable.

Examples of the nitrogen-containing phenol novolak resin including a structural unit derived from melamine include a phenol novolak resin represented by the following formula (1).

In formula (1), values of m and n each represent the number of structural units. For example, m and n are each independently selected from a range of 1 to 100.

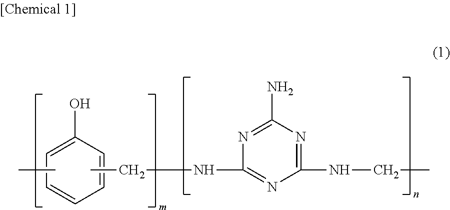

From the viewpoint of increasing the adhesion of the resin member with respect to the metal film, a ratio of the nitrogen-containing phenol novolak resin in the entire material of the resin member is preferably 0.1 mass % or more, more preferably 0.2 mass % or more, and even more preferably 0.3 mass % or more.

The ratio of the nitrogen-containing phenol novolak resin in the entire material of the resin member is preferably 10 mass % or less, more preferably 5 mass % or less, and even more preferably 1 mass % or less, of the entire material of the resin member.

The curing agent used in the cured product of the epoxy resin and the curing agent may be solely the nitrogen-containing phenol novolak resin, or may be a combination of the nitrogen-containing phenol novolak resin and any other curing agent.

From the viewpoint of increasing the adhesion of the resin member with respect to the metal film, a ratio of the nitrogen-containing phenol novolak resin in the entire curing agent is preferably 1 mass % or more, more preferably 2 mass % or more, and even more preferably 5 mass % or more. The ratio of the nitrogen-containing phenol novolak resin in the entire curing agent is preferably 30 mass % or less, more preferably 20 mass % or less, and even more preferably 10 mass % or less, of the entire curing agent.

Specific examples of a curing agent (any other curing agent) other than the nitrogen-containing phenol novolak resin include a phenol curing agent, an amine curing agent, an acid anhydride curing agent, a polymercaptan curing agent, a polyaminoamide curing agent, an isocyanate curing agent, a blocked isocyanate curing agent, and an active ester compound. Among them, a phenol curing agent is preferable. One of the curing agents may be used alone, or two or more thereof may be used in combination.

Specific examples of the phenol curing agent include: a polyphenol compound, such as resorcinol, catechol, bisphenol A, bisphenol F, and a substituted or unsubstituted biphenol; novolak-type phenol resin, obtained by condensation or co-condensation under an acidic catalyst of at least one phenolic compound selected from the group consisting of phenol compounds such as phenol, cresol, xylenol, resorcinol, catechol, bisphenol A, bisphenol F, phenylphenol, and aminophenol, and naphthol compounds such as β-naphthol, β-naphthol, and dihydroxynaphthalene, with an aldehyde compound such as formaldehyde, acetaldehyde, and propionaldehyde; aralkyl-type phenol resin, such as phenol aralkyl-type phenol resin, biphenyl aralkyl-type phenol resin, and naphthol aralkyl-type phenol resin; paraxylylene-modified phenol resin, metaxylylene-modified phenol resin; melamine-modified phenol resin; terpene-modified phenol resin; dicyclopentadiene-type phenol resin and dicyclopentadiene-type naphthol resin, synthesized by copolymerization of the aforementioned phenolic compound and dicyclopentadiene; cyclopentadiene-modified phenol resin; polycyclic aromatic ring-modified phenol resin; biphenyl-type phenol resin; triphenylmethane-type phenol resin, obtained by condensation or co-condensation under an acidic catalyst of the aforementioned phenolic compound with an aromatic aldehyde compound such as benzaldehyde and salicylaldehyde; and phenol resin, obtained by copolymerization of two or more of the foregoing. One of the phenol curing agents may be used alone, or two or more thereof may be used in combination.

From the viewpoint of heat resistance of the resin member, triphenylmethane-type phenol resin, biphenyl aralkyl-type phenol resin, naphthalene aralkyl-type phenol resin, and novolak-type phenol resin are preferable as the any other curing agent.

In the case where the curing agent is solid, a softening point or melting point thereof is not particularly limited. From the viewpoint of moldability and reflow resistance, the softening point or melting point is preferably 40° C. to 180° C.; from the viewpoint of handleability, the softening point or melting point is more preferably 50° C. to 130° C.

The melting point or softening point of the curing agent is a value measured in the same manner as the melting point or softening point of the epoxy resin.

An equivalent ratio between the epoxy resin and the curing agent, that is, a ratio (number of functional groups in curing agent/number of functional groups in epoxy resin) of the number of functional groups in the curing agent to the number of functional groups in the epoxy resin, is not particularly limited. From the viewpoint of suppressing unreacted portions of each component, the ratio is preferably set in a range of 0.5 to 2.0, and more preferably set in a range of 0.6 to 1.3. From the viewpoint of moldability and reflow resistance, the ratio is even more preferably set in a range of 0.8 to 1.2.

### (Curing Accelerator)

The resin member may further include a curing accelerator.

The type of the curing accelerator is not particularly limited, and examples include: diazabicycloalkene, such as 1,5-diazabicyclo[4.3.0]non-5-ene (DBN) and 1,8-diazabicyclo[5.4.0]undec-7-ene (DBU); a cyclic amidine compound, such as 2-methylimidazole, 2-phenylimidazole, 2-phenyl-4-methylimidazole, and 2-heptadecylimidazole; a derivative of the aforementioned cyclic amidine compound; a phenol novolak salt of the aforementioned cyclic amidine compound or a derivative thereof; a compound having intramolecular polarization, formed by adding a compound having a π bond, such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, and phenyl-1,4-benzoquinone, and diazophenylmethane to these compounds; a cyclic amidinium compound, such as a tetraphenylborate salt of DBU, a tetraphenylborate salt of DBN, a tetraphenylborate salt of 2-ethyl-4-methylimidazole, and a tetraphenylborate salt of N-methylmorpholine; a tertiary amine compound, such as pyridine, triethylamine, triethylenediamine, benzyldimethylamine, triethanolamine, dimethylaminoethanol, and tris(dimethylaminomethyl) phenol; a derivative of the aforementioned tertiary amine compound; an ammonium salt compound, such as tetra-n-butylammonium acetate, tetra-n-butylammonium phosphate, tetraethylammonium acetate, tetra-n-hexylammonium benzoate, and tetrapropylammonium hydroxide; an organic phosphine, such as a primary phosphine, such as ethylphosphine and phenylphosphine, a secondary phosphine, such as dimethylphosphine and diphenylphosphine, and a tertiary phosphine, such as triphenylphosphine, diphenyl(p-tolyl)phosphine, tris(alkylphenyl)phosphine, tris(alkoxyphenyl) phosphine, tris(alkylalkoxyphenyl) phosphine, tris(dialkylphenyl) phosphine, tris(trialkylphenyl) phosphine, tris(tetraalkylphenyl) phosphine, tris(dialkoxyphenyl) phosphine, tris(trialkoxyphenyl) phosphine, tris(tetraalkoxyphenyl) phosphine, trialkylphosphine (such as tributylphosphine), dialkylalylphosphine, alkyldiarylphosphine, trinaphthylphosphine, and tris(benzyl) phosphine; a phosphine compound, such as a complex of the aforementioned organic phosphine and organoborons; a compound having intramolecular polarization, formed by adding a compound having a π bond, such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone, phenyl-1,4-benzoquinone, and anthraquinone, and diazophenylmethane to the aforementioned organic phosphine or the aforementioned phosphine compound; a compound having intramolecular polarization, obtained by reacting the aforementioned organic phosphine or the aforementioned phosphine compound with a halogenated phenol compound such as 4-bromophenol, 3-bromophenol, 2-bromophenol, 4-chlorophenol, 3-chlorophenol, 2-chlorophenol, 4-iodophenol, 3-iodophenol, 2-iodophenol, 4-bromo-2-methylphenol, 4-bromo-3-methylphenol, 4-bromo-2,6-dimethylphenol, 4-bromo-3,5-dimethylphenol, 4-bromo-2,6-di-t-butylphenol, 4-chloro-1-naphthol, 1-bromo-2-naphthol, 6-bromo-2-naphthol, and 4-bromo-4′-hydroxybiphenyl, followed by a dehydrohalogenation process; a tetrasubstituted phosphonium compound, such as tetrasubstituted phosphonium such as tetraphenylphosphonium, a tetraphenylborate salt of tetrasubstituted phosphonium such as tetraphenylphosphonium tetra-p-tolylborate, and a salt of tetrasubstituted phosphonium and a phenol compound; a phosphobetaine compound; and an adduct of a phosphonium compound and a silane compound. Among them, triphenylphosphine and an adduct of triphenylphosphine and a quinone compound are preferable.

One of the curing accelerators may be used alone, or two or more thereof may be used in combination.

The amount of the curing accelerator included in the resin member is preferably 0.1 part by mass to 30 parts by mass, and more preferably 1 part by mass to 15 parts by mass, with respect to 100 parts by mass of a resin component (for example, the total amount of the epoxy resin and the curing agent). When the amount of the curing accelerator is 0.1 part by mass or more with respect to 100 parts by mass of the resin component, good curing tends to be achieved in a short time. When the amount of the curing accelerator is 30 parts by mass or less with respect to 100 parts by mass of the resin component, a good cured product tends to be obtained without a curing speed being excessively high.

### (Filler)

The resin member may include a filler. The type of the filler is not particularly limited. Specific examples of the filler include an inorganic material, such as silica (such as fused silica and crystalline silica), glass, alumina, talc, clay, and mica. An inorganic filler having a flame-retardant effect may be used. Examples of the inorganic filler having a flame-retardant effect include aluminum hydroxide, magnesium hydroxide, a composite metal hydroxide such as a composite hydroxide of magnesium and zinc, and zinc borate.

Among the inorganic fillers, silica is preferable from the viewpoint of reducing the coefficient of linear expansion, and alumina is preferable from the viewpoint of high thermal conductivity. One of the inorganic fillers may be used alone, or two or more thereof may be used in combination. Examples of the form of the inorganic filler include powder, beads formed by spheroidizing powder, and fibers.

A volume average particle diameter of the filler included in the resin member is preferably 10 μm or less, preferably 1 μm to 8 μm, and more preferably 2 μm to 6 μm.

A maximum particle diameter of the filler included in the resin member is preferably 50 μm or less, and more preferably 30 μm or less.

The resin member may include a filler having a volume average particle diameter of 0.1 μm or less. In the case where the resin member includes a filler having a volume average particle diameter of 0.1 μm or less, the content ratio of such filler is preferably 10 mass % or less, more preferably 5 mass % or less, and even more preferably 3 mass % or less, of the entire filler. The above-mentioned content ratio may be 0.1 mass % or more of the entire filler.

In the disclosure, the volume average particle diameter of the filler is a particle diameter (D50) at which a cumulative volume from a small diameter side reaches 50% in a volume-based particle size distribution obtained using a laser diffraction/scattering particle size distribution analyzer (for example, LA-920 manufactured by HORIBA, Ltd.).

In the case where the filler is included in the resin member, the volume average particle diameter of the filler extracted from the resin member may be measured by a method such as thermal decomposition or dissolution.

The content ratio of the filler included in the resin member is not particularly limited. From the viewpoint of flowability and strength, the content ratio is preferably 30 volume % to 90 volume %, more preferably 35 volume % to 80 volume %, and even more preferably 50 volume % to 80 volume %, of the entire resin member. When the content ratio of the filler is 30 volume % or more of the entire resin member, characteristics such as the coefficient of thermal expansion, thermal conductivity, and elastic modulus of the cured product tend to be improved. When the content ratio of the filler is 90 volume % or less of the entire resin member, an increase in viscosity of a material of the resin member tends to be suppressed, flowability tends to be enhanced, and moldability tends to be improved.

### (Silane Compound)

The resin member may further include a silane compound.

Specific examples of the silane compound include dimethoxydiphenylsilane, vinyltrichlorosilane, vinyltriethoxysilane, vinyltris(β-methoxyethoxy) silane, γ-methacryloxypropyltrimethoxysilane, β-(3,4-epoxycyclohexyl)ethyltrimethoxysilane, γ-glycidoxypropyltrimethoxysilane, vinyltriacethoxysilane, γ-mercaptopropyltrimethoxysilane, N-phenyl-γ-aminopropyltrimethoxysilane, γ-aminopropyltriethoxysilane, γ-[bis(β-hydroxyethyl)]aminopropyltriethoxysilane, N-β-(aminoethyl)-γ-aminopropyltrimethoxysilane, γ-(β-aminoethyl)aminopropyldimethoxymethylsilane, N-(trimethoxysilylpropyl)ethylenediamine, N-(dimethoxymethylsilylisopropyl)ethylenediamine, methyltrimethoxysilane, methyltriethoxysilane, N-β-(N-vinylbenzylaminoethyl)-γ-aminopropyltrimethoxysilane, γ-chloropropyltrimethoxysilane, hexamethyldisilane, γ-anilinopropyltrimethoxysilane, vinyltrimethoxysilane, and γ-mercaptopropylmethyldimethoxysilane. One of the silane compounds may be used alone, or two or more thereof may be used in combination.

In the case where the resin member includes a silane compound, a content ratio of the silane compound is preferably 0.1 mass % to 3 mass % or less with respect to the entire resin member. Alternatively, the amount of the silane compound is preferably 0.05 part by mass to 10 parts by mass, and more preferably 0.1 part by mass to 8 parts by mass, with respect to 100 parts by mass of the filler included in the resin member.

### (Coloring Agent)

The resin member may include a coloring agent. Examples of the coloring agent include a known coloring agent such as carbon black, an organic dye, an organic pigment, titanium oxide, red lead, and bengala. The content of the coloring agent can be appropriately selected according to the application of the structure or the like. One of the coloring agents may be used alone, or two or more thereof may be used in combination.

### (Ion Exchanger)

The resin member may include an ion exchanger. For example, in the case of using the structure as an electronic component device having an element built therein, an ion exchanger may be included from the viewpoint of improving moisture resistance and high-temperature storage characteristics of the electronic component device. Examples of the ion exchanger include a hydrotalcite compound, as well as hydrated hydroxide of at least one element selected from the group consisting of magnesium, aluminum, titanium, zirconium, and bismuth. One of the ion exchangers may be used alone, or two or more thereof may be used in combination. Among them, hydrotalcite represented by the following general formula (A) is preferable.

Mg_{(1-X)}Al_{X}(OH)₂(CO₃)_{X/2}·mH₂O (A)
(0<X≤0.5, and m is a positive number)

### (Flame Retardant)

The resin member may include a flame retardant. The flame retardant is not particularly limited, and a conventionally known flame retardant can be used. Specific examples include an organic or inorganic compound containing halogen atoms, antimony atoms, nitrogen atoms, or phosphorus atoms, and a metal hydroxide. One of the flame retardants may be used alone, or two or more thereof may be used in combination.

### (Wax)

The resin member may include a wax. Specific examples of the wax include: a polyolefin-based wax, such as oxidized polyethylene wax and non-oxidized polyethylene wax; a plant-based wax, such as carnauba wax; a mineral-based wax, such as montan wax; a petroleum-based wax, such as paraffin wax and microcrystalline wax; and a higher fatty acid such as stearic acid or a salt thereof. The wax included in the resin member may be of a single type or of two or more types.

### <Electronic Component Device>

An electronic component device of the disclosure includes the structure described above.

The structure included in the electronic component device of the disclosure excels in adhesion between the resin member and the metal film arranged on the surface of the resin member. Hence, the electronic component device of the disclosure is capable of sustainably achieving an excellent electromagnetic interference suppression effect.

The electronic component device of the disclosure may include, for example, a support member, an element arranged on the support member, a resin member arranged around the element, and a metal film arranged on a surface of the resin member.

Examples of the electronic component device include one in which the element (such as an active element such as a semiconductor chip, a transistor, a diode, and a thyristor, or a passive element such as a capacitor, a resistor, and a coil) is mounted on the support member such as a lead frame, a wired tape carrier, a wiring board, glass, a silicon wafer, and an organic substrate, and a periphery of the element is sealed with the resin member.

More specific examples include: a general resin-sealed IC, such as dual in-line package (DIP), plastic leaded chip carrier (PLCC), quad flat package (QFP), small outline package (SOP), small-outline J-leaded package (SOJ), thin small outline package (TSOP), and thin quad flat package (TQFP), having a structure in which the element is fixed on a lead frame, a terminal part of the element such as a bonding pad and a lead part are connected by wire bonding, bumps or the like, and then sealed with the resin member; a tape carrier package (TCP), having a structure in which the element connected to a tape carrier by bumps is sealed with the resin member; a chip on board (COB) module, a hybrid IC, and a multi-chip module, having a structure in which the element connected to wiring formed on the support member by wire bonding, flip chip bonding, solder or the like is sealed with the resin member; and a ball grid array (BGA), a chip size package (CSP), and a multi-chip module (MCP), having a structure in which the element is mounted on a surface of the support member that has a terminal for connecting to a wiring board formed on a back surface, the element and wiring formed on the support member are connected by bumps or wire bonding, and then the element is sealed with the resin member.

### <Method for Manufacturing Structure>

A method for manufacturing a structure of the disclosure is the following method for manufacturing a structure. The method includes a process of preparing a resin member and a process of arranging a metal film on a surface of the resin member, in which the resin member includes a wax.

In the method of the disclosure, the metal film is formed on the surface of the resin member in a solid state. Hence, compared to a case of, for example, curing a material having flowability, such as an uncured thermoplastic resin, while the material is in contact with a metal member, and manufacturing a structure, sufficient adhesion between the resin member and the metal film may not be obtained.

In the method of the disclosure, the fact that the resin member includes a cured product of an epoxy resin and a curing agent and that a nitrogen-containing phenol novolak resin is included as the curing agent acts to increase the adhesion of the surface of the resin member with respect to the metal film. As a result, it is conceivable that a decrease in the adhesion between the resin member and the metal film is suppressed.

In the method of the disclosure, a method for obtaining the resin member is not particularly limited and can be selected according to a component included in the resin member or the like.

For example, the resin member may be obtained by curing a material including a thermosetting resin.

Specific examples of a method for curing the material including a thermosetting resin include a compression molding method, an injection molding method, and a transfer molding method.

The material including a thermosetting resin before curing may be either liquid or solid.

A method for arranging the metal film on the surface of the resin member is not particularly limited.

Examples of the method include sputtering, vapor deposition, plating, and paste application.

A material of the metal film is not particularly limited. Examples thereof include copper, silver, iron, nickel, aluminum, titanium, vanadium, chromium, and alloys containing these metals.

A thickness of the metal film is not particularly limited, and can be selected from, for example, a range of 10 nm to 1000 μm.

In the method of the disclosure, the metal film may be arranged on the entire surface of the resin member, or the metal film may be arranged on a portion of the surface of the resin member.

The method of the disclosure may further include selecting the resin member to be used in the structure based on information obtained from an evaluation method including (A), (B), and (C) described below.
(A) A test specimen is prepared including a resin member and a metal film arranged on a surface of the resin member.
(B) As a pretreatment of the test specimen, the following are performed in this order: a treatment in which the test specimen is held in an environment of 60° C. to 100° C. and relative humidity of 60% to 100% for 15 hours or more; and a treatment in which the test specimen is heated under conditions where a maximum attained temperature is 200° C. or higher.
(C) A peeling test of the metal film is conducted using the test specimen after pretreatment.

By selecting the resin member to be used in the structure based on information obtained from the evaluation method including (A), (B), and (C), a structure that excels in adhesion can be effectively manufactured.

A method for preparing the test specimen including the resin member and the metal film arranged on the surface of the resin member is not particularly limited. For example, a method in accordance with the method for manufacturing a structure of the disclosure may be selected.

In the pretreatment of the test specimen, the treatment (hereinafter also referred to as moisture absorption treatment) in which the test specimen is held in an environment of 60° C. to 100° C. and relative humidity of 60% to 100% for 15 hours or more and the treatment (hereinafter also referred to as heat treatment) in which the test specimen is heated under conditions where the maximum attained temperature is 200° C. or higher are performed in this order.

In the moisture absorption treatment, the test specimen is held in the environment of 60° C. to 100° C. and relative humidity of 60% to 100% for 15 hours or more.

The temperature of the moisture absorption treatment is not particularly limited as long as it is within the range of 60° C. to 100° C., and may be, for example, 85° C.

The relative humidity of the moisture absorption treatment is not particularly limited as long as it is within the range of 60% to 100%, and may be, for example, 85%.

The duration of the moisture absorption treatment is not particularly limited as long as it is 15 hours or more, and may be, for example, 15 hours to 200 hours, or may be 24 hours.

In the heat treatment, the test specimen is heated under conditions where the maximum attained temperature is 200° C. or higher.

The maximum attained temperature of the heat treatment is not particularly limited as long as it is 200° C. or higher, and may be, for example, 200° C. to 300° C., or may be 260° C.

The heat treatment may be performed in the atmosphere or in an inert atmosphere such as nitrogen. In the case where the metal film is made of an easily oxidizable metal such as copper, it is preferable to perform the heat treatment in an inert atmosphere.

The number of times the heat treatment is performed is not particularly limited. From the viewpoint of evaluation accuracy, it is preferable to perform the heat treatment two or more times, and more preferably three or more times.

A method for conducting the peeling test on the test specimen is not particularly limited. Examples of the method include cross-cut test, peel test, scratch test, and cross-cut adhesion test.

The criteria for evaluating a result obtained by the peeling test are not particularly limited and can be set to achieve desired evaluation accuracy.

### EXAMPLES

Hereinafter, the disclosure will be described in more detail according to examples. However, the scope of the disclosure is not limited to these examples.

### <Preparation of Test Specimen>

A test specimen with a metal film arranged on a surface of a resin member was prepared using a composition including materials shown in Table 1.

Specifically, the composition including the materials shown in Table 1 was molded on a substrate under conditions of a mold temperature of 175° C. and a molding time of 120 seconds. After that, the substrate was peeled off, and post-curing was performed at 175° C. for 5 hours to obtain a cured product of 235 mm×65 mm×0.7 mm. A copper film (thickness: 500 μm) was formed by sputtering on one main surface and a side surface of the obtained cured product to obtain the test specimen.

### <Evaluation of Adhesion>

The test specimen was subjected to the moisture absorption treatment by being held in an environment at 85° C. and relative humidity of 85% for 24 hours. After that, the heat treatment was performed three times in a nitrogen atmosphere with the maximum temperature of 260° C.

A cross-cut test in accordance with JIS K 5600 was conducted on the test specimen after the above treatments. The number of measurements (N number) was set to 3.

Specifically, incisions were made at 1 mm intervals on the metal film of the test specimen to form 25 squares (5 vertical×5 horizontal), and tape was attached thereon. Within 5 minutes after attachment of the tape, the tape was quickly removed at an angle of 60° in 0.5 to 1.0 seconds. The adhesion of the metal film was evaluated in accordance with the following criteria according to a ratio (area basis) of the metal film remaining after removal of the tape. The result is shown in Table 1.
1: less than 5%
2: 5% or more and less than 15%
3: 15% or more and less than 35%
4: 35% or more and less than 65%
5: 65% or more

### <Evaluation of Flowability>

A composition including the materials shown in Table 1 was molded using a mold for spiral flow measurement in accordance with EMMI 1-66 under conditions of a molding pressure of 6.9 MPa, a curing time of 120 seconds, and a molding temperature of 180° C., and a flow distance (cm) was obtained. A result (SF) is shown in Table 1.

### <Evaluation of Elastic Modulus, Flexural Strength, and Elongation at Break>

A composition including the materials shown in Table 1 was molded under conditions of a molding pressure of 6.9 MPa, a curing time of 120 seconds, and a molding temperature of 175° C., and a test specimen having dimensions of 70 mm×10 mm×3 mm was prepared. A three-point bending test in accordance with JIS K 6911 (2006) was conducted at 25° C. using Tensilon manufactured by A&D, and an elastic modulus, a flexural strength, and elongation at break of the test specimen were obtained. The result is shown in Table 1. An elastic modulus E is defined by the following expression.

In the following expression, E is elastic modulus (MPa), P is load cell value (N), y is displacement amount (mm), 1 is span=48 mm, w is width of the test specimen=10 mm, and h is thickness of the test specimen=3 mm.

$$E = \frac{{l}^{3}}{4 {wh}^{3}} \frac{Δ P}{Δ y} \qquad [ Math 1 ]$$

TABLE 1

| | Comparative | |
|---|---|---|
| | Example 1 | Example 1 |
| Epoxy resin 1 | 50 | 50 |
| Epoxy resin 2 | 50 | 50 |
| Curing agent 1 | 59 | 54.8 |
| Curing agent 2 | 0 | 4.67 |
| Curing accelerator | 1.6 | 1.6 |
| Coupling agent 1 | 2 | 2 |
| Coupling agent 2 | 2 | 2 |
| Coloring agent | 3.5 | 3.5 |
| Filler 1 | 805 | 807 |
| Filler 2 | 43 | 43 |
| Filler 3 | 7 | 7 |
| Total (part by mass) | 1023.1 | 1025.6 |
| Filler (volume %) | 72.5 | 72.5 |
| Adhesion | 5 | 3 |
| SF (cm) | 235 | 232 |
| Elongation at break (%) | 68% | 91% |
| Flexural modulus (GPa) | 20.2 | 20.6 |
| Bending strength (MPa) | 121 | 143 |

Details of the materials shown in Table 1 are as follows.
Epoxy resin 1: biphenyl-type epoxy resin, having an epoxy equivalent of 192
Epoxy resin 2: triphenylmethane-type epoxy resin, having an epoxy equivalent of 169
Curing agent 1: phenol aralkyl-type phenol resin not containing nitrogen atoms, having a hydroxyl group equivalent of 106
Curing agent 2: phenol novolak resin having the structure represented by formula (1)
Curing accelerator: adduct of triphenylphosphine and p-benzoquinone
Coupling agent 1: N-phenyl-γ-aminopropyltrimethoxysilane
Coupling agent 2: γ-glycidoxypropyltrimethoxysilane
Coloring agent: carbon black
Filler 1: fused silica, having a volume average particle diameter of 15 μm and a specific surface area of 2.7 m²/g
Filler 2: fused silica, having a volume average particle diameter of 0.5 μm and a specific surface area of 6.3 m²/g
Filler 3: fused silica, having a volume average particle diameter of 0.1 μm or less and a specific surface area of 205 m²/g

As shown in the result above, compared to the test specimen of Comparative Example 1 that did not use a nitrogen-containing phenol novolak resin as the curing agent, the test specimen of Example 1 that used a nitrogen-containing phenol novolak resin as the curing agent exhibited superior adhesion to the metal film in the evaluation.

The disclosure of Japanese Patent Application No. 2022-188726 is incorporated herein by reference in its entirety.

All literatures, patent applications and technical standards described in the present specification are incorporated by reference herein to the same degree as in the case where the individual literatures, patent applications and technical standards are specifically and individually described by reference.

1. A structure, comprising:
a resin member; and
a metal film, arranged on a surface of the resin member, wherein
the resin member comprises a cured product of an epoxy resin and a curing agent; and the curing agent comprises a nitrogen-containing phenol novolak resin.

2. The structure according to claim 1, wherein
the nitrogen-containing phenol novolak resin comprises a structural unit derived from a triazine compound.

3. The structure according to claim 1, wherein
the nitrogen-containing phenol novolak resin comprises a structural unit derived from melamine.

4. The structure according to claim 1, wherein
the resin member comprises a cured product of a thermosetting resin.

5. The structure according to claim 4, wherein
the thermosetting resin comprises an epoxy resin.

6. An electronic component device, comprising the structure according to claim 1.

7. A method for manufacturing a structure, comprising:
preparing a resin member; and
arranging a metal film on a surface of the resin member, wherein
the resin member comprises a cured product of an epoxy resin and a curing agent; and the curing agent comprises a nitrogen-containing phenol novolak resin.

8. The method for manufacturing a structure according to claim 7, further comprising:
selecting the resin member based on information obtained from an evaluation method comprising (A), (B), and (C) described below:
(A) preparing a test specimen comprising a resin member and a metal film arranged on a surface of the resin member;
(B) performing, as a pretreatment of the test specimen, in this order: a treatment in which the test specimen is held in an environment of 60° C. to 100° C. and relative humidity of 60% to 100% for 15 hours or more; and a treatment in which the test specimen is heated under conditions where a maximum attained temperature is 200° C. or higher;
(C) conducting a peeling test of the metal film using the test specimen after pretreatment.
